(19) United States
(12) Patent Application Publication
(10) Pub. No.: US 2009/0032539 A1
(43) Pub. Date: Feb. 5, 2009

(54) Suspension Assembly For Mechanically Retaining a First Article by Bracing it Against a Second Article

(75) Inventor: Matthew Hobbs, Oxford (GB)

Correspondence Address: CROWELL & MORING LLP;INTELLECTUAL PROPERTY GROUP, P.O. BOX 14300, WASHINGTON, DC, 20044-4300, US

(73) Assignee: Siemens Magnet Technology Limited, Witney (GB)

(21) Appl. No.: 12/243,502

(22) Filed: Oct. 1, 2008

Related U.S. Application Data
(63) Continuation of application No. PCT/GB2007/050248, filed on May 10, 2007.

(30) Foreign Application Priority Data
May 10, 2006 (GB) 0609247.2

(51) Int. Cl. F17C 13/08

(52) U.S. Cl. 220/560.1

(57) ABSTRACT

A suspension assembly for mechanically retaining a first article by bracing it against a second article includes a spherical or spheroid object located between first and second articles. A first set of at least three rounded surfaces is mechanically braced between the spherical or spheroid object and the first article, with each of such surfaces being in contact with the spheroid object at a single point; and a second set of at least three rounded surfaces mechanically is braced between the spherical or spheroid object and the second article, with each of said surfaces being in contact with the spherical or spheroid object at a single point.

### CROSS-REFERENCE TO RELATED APPLICATIONS

This application is related to co-pending U.S. patent application serial number ______, filed concurrently herewith, and entitled “Suspension assembly for mechanically retaining a first article by bracing it against a second article.

### BACKGROUND OF THE INVENTION

This application is a continuation of PCT International Application No. PCT/GB2007/050248, filed May 10, 2007, which claims priority under 35 U.S.C. §119 to British Patent Application No. 0609247.2, filed May 10, 2006, the entire disclosure of which is herein expressly incorporated by reference.

### SUMMARY OF THE INVENTION

The present invention relates to a suspension assembly and a suspension system for supporting a first article by bracing it against a second article. While the suspension assembly and suspension system of the present invention is of general application, and may find use in many constructions, it is considered to be particularly useful in retaining containers one inside the other, with precisely defined separation between the respective walls of the containers. An example of such use is in retaining cryogen vessels within outer vacuum containers in cryostats, for example those used for accommodating magnets for MRI imaging systems. Another application lies in the retaining of a cryogen vessel within outer vacuum container in cryostats used for cryogenic storage of liquefied gases. The present invention is particularly advantageous when an intermediate article must be suspended between the first and second articles. In the example of cryogen vessels within an outer vacuum container, the intermediate article will typically be a thermal radiation shield, located concentrically with the cryogen vessel and the outer vacuum container, and intermediate between them.

Known systems comprising a cryogen vessel and radiation shield/s suspended within a vacuum vessel are commonly suspended using tensile elements with a low thermal conductivity and small cross-sectional area to reduce the heat flow to the cryogen vessel. These tensile elements are made as long as is possible to maximise their effectiveness by reducing their thermal conductivity. In certain configurations the design of the vessels is not conducive to long, tensile elements and a shorter, more compact element would be more suitable. The present invention addresses this need, and in certain embodiments aims to provide a suspension system suitable for cryogen vessels wherein placement of long tensile elements is not possible, or not desirable.

The present invention relies on the use of hard materials in certain shapes to ensure a minimum contact area between articles, so minimising thermal conduction between the articles. The suspension system of the present invention is also very compact, requiring only a small separation distance between the articles. The suspension system of the present invention is also particularly robust and simple to adjust.

Accordingly, the present invention provides suspension systems as defined in the appended claims.

The above, and further, objects, characteristics and advantages of the present invention will become more apparent from consideration of the following description of certain embodiments thereof, in conjunction with the accompanying drawing, wherein:

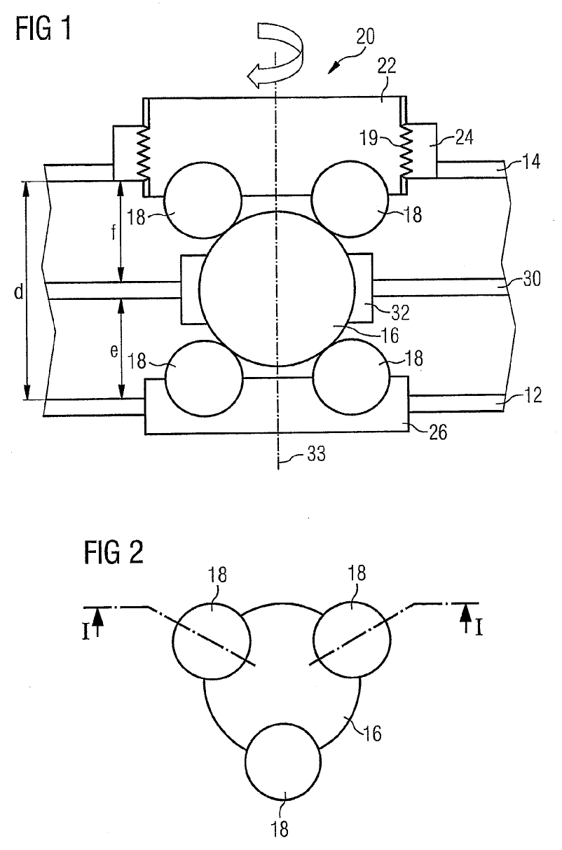

FIG. 1 illustrates an elevation view of a suspension assembly according to a first exemplary embodiment of the invention;

FIG. 2 illustrates a plan view of the suspension assembly of FIG. 1;

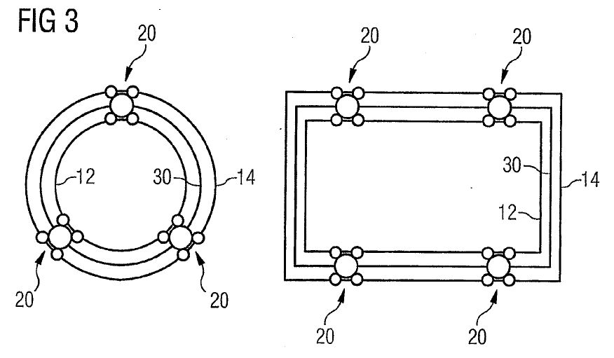

FIG. 3 illustrates a suspension system, according to an embodiment of the invention, which employs six suspension assemblies such as shown in FIGS. 1 and 2;

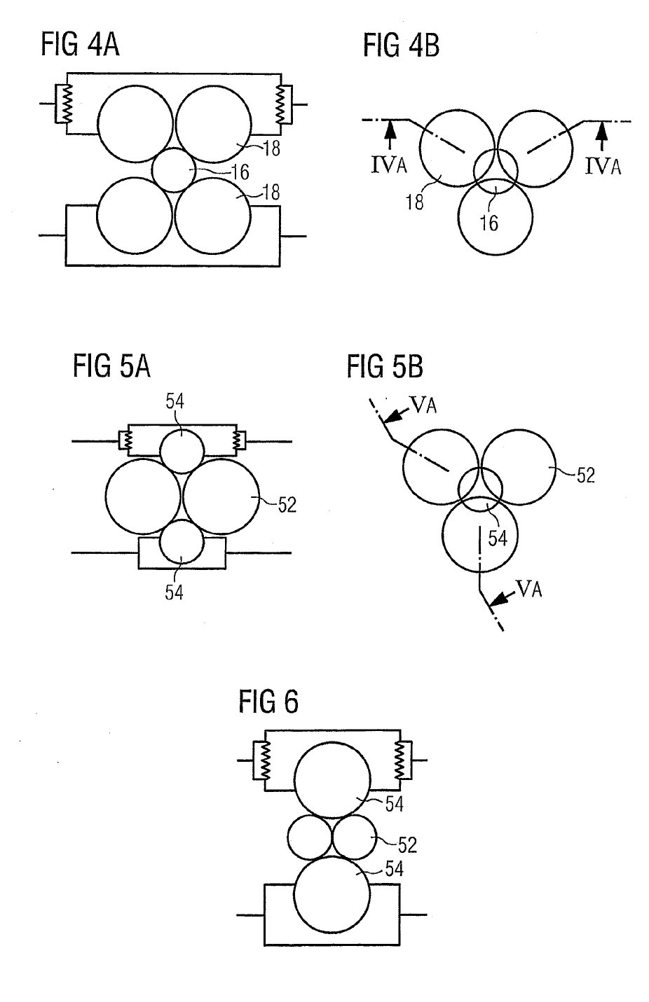

FIGS. 4A and 4B show views analogous to those of FIGS. 1 and 2 of an embodiment in which a central spherical element is smaller than the outer spherical elements;

FIGS. 5A and 5B show views analogous to those of FIGS. 1 and 2 of an embodiment in which a set of at least three central spherical elements are provided, braced against a single outer spherical element on each side;

FIG. 6 shows a view analogous to that of FIGS. 1 and 5A, of an embodiment of the present invention wherein a set of at least three central spherical elements are provided, braced against a single outer spherical element on each side;

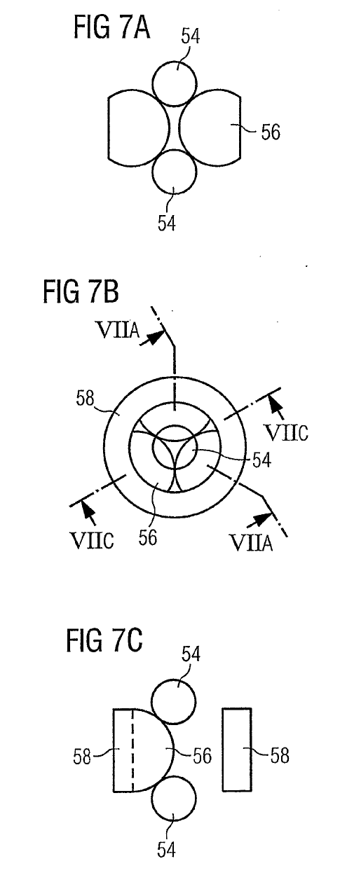

FIGS. 7A-7C show a refinement of the embodiment of FIGS. 5A-5B, in which only the relevant part of the spherical surfaces of the central spherical elements are provided;

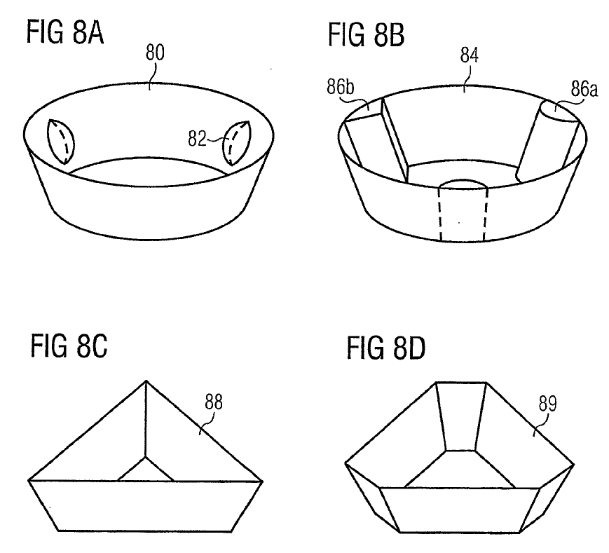

FIGS. 8A-8D show perspective views of cups which may be employed according to a further set of embodiments of the present invention;

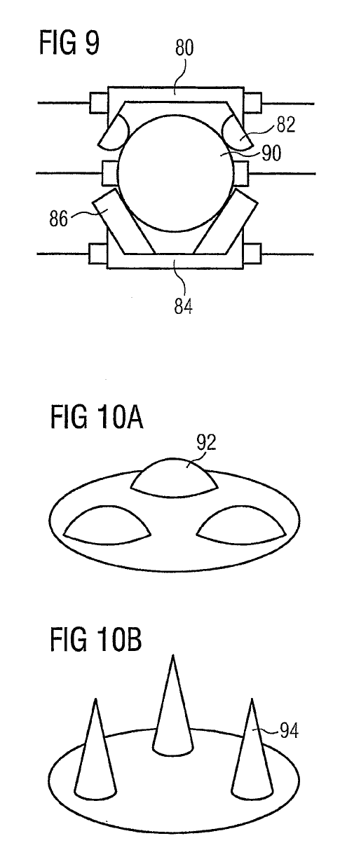

FIG. 9 shows a cross-section, analogous to that of FIG. 1, of the cups of FIGS. 8A and 8B in use in an embodiment of the present invention;

FIGS. 10A-10B illustrate alternative “cup” members for use in embodiments similar to those of FIGS. 8A-9;

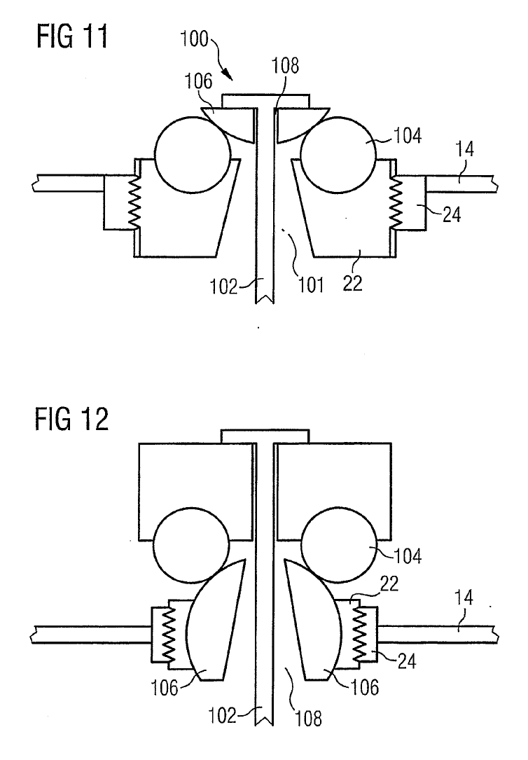

FIG. 11 illustrates a suspension assembly according to another embodiment of the present application; and

FIGS. 12-14 show variations on the embodiment of FIG. 11.

The present invention advantageously employs the minimal contact area between two hard surfaces, of which at least one is non-planar, in order to provide a rigid suspension system which is easy to adjust and which has minimal thermal conductivity. In preferred embodiments, spherical or spheroid surfaces are employed, as described below, but other surfaces could be used.

FIGS. 1 and 2 illustrate a first, exemplary, embodiment of the present invention. FIG. 2 illustrates a plan view of certain elements of the suspension assembly illustrated in FIG. 1, which FIG. 1 illustrates a section through a suspension assembly along the line I-I in FIG. 2. A first article 12, in this example being a cryogen vessel, is braced against a second article 14, in this example being an outer vacuum container. A plurality of suspension assemblies 20 are provided, each providing mechanical bracing of the first article against the second article. Preferably, the suspension assemblies 20 will be at least six in number, although arrangements having less than six are possible. FIG. 3 illustrates a preferred embodiment, in which six suspension assemblies 20, each as illustrated in FIGS. 1 and 2, are employed to retain one cylindrical article within another. Three suspension assemblies 20 are provided at each end, equally spaced around the circumference of the cylindrical articles.

In the illustrated embodiment, the suspension assembly 20 comprises a central spherical element 16 retained against the first article 12 by a group of at least three outer spherical elements 18. The opposing side of the central spherical element 16 is preferably retained against the second article 14 in an identical manner.

A housing 22 for the outer spherical elements 18 between the central spherical element 16 and the second article 14 could be threaded 19 on its outer periphery and retained within a threaded carrier 24, thereby allowing rotation of the housing 22 to apply preload to the suspension assembly 20. After suitable adjustment, the position of housing 22 within the threaded carrier 24 may be locked and sealed by welding the housing 22 to the threaded carrier 24. Alternatively for an adjustable system an ‘o’ ring style seal could be used. It is generally sufficient for only one side of the suspension assembly to be adjustable, since preload applied from one side will preload the whole assembly. A housing 26 for the outer spherical elements 18 between the central spherical element 16 and the first article 12 could be fixed, as shown in FIG. 1. Of course, this housing may be adjustable, as shown at 22, 24 if preferred.

While the described adjustment 22, 24 is useful in providing a preload on the suspension assembly 20, the same adjustment method may be applied to adjust the relative position of the cryogen vessel, first article 12, within the outer vacuum container, second article 14.

In the illustrated embodiment, an intermediate article 30, in this example a thermal radiation shield, is retained between the first article 12 and the second article 14. This intermediate article is, in the illustrated embodiment, restrained by a retainer 32 mounted on the central spherical element 16. The suspension assemblies 20 typically serve to hold first and second articles at a predetermined separation d, and to retain the intermediate article 30, if any, at predetermined distances e, f, from the first and second articles. As may be appreciated from consideration of FIG. 1, these distances are functions of the diameters of the central spherical element 16 and the outer spherical elements 18, the radial displacement of the outer spherical elements 18 from central axis 33, and the applied preload.

A particular feature of the suspension system of the present invention is that only minimal surface area of physical contact is present between the central element 16 and the outer elements 18. This ensures a correspondingly low thermal conduction between first and second articles. In the embodiment illustrated in FIG. 1, the spherical components 16, 18 touch each other at a single point. They should each be made of a hard material, at least on the surface in the contact regions, so that the area of contact does not increase significantly when the suspension assembly is preloaded, or loaded with the weight of the first and second articles. The elements 16, 18 must have a compressive strength adequate to support the loads of the system without yielding and therefore increasing the contact area between elements. While the elements 16, 18, or at least some of them, should preferably have a low thermal conductivity, the limitation on thermal conduction between first and second articles is predominantly achieved by the small contact surface area rather than the thermal conductivity of the materials themselves.

Suitable hard materials may be: hardened steels (e.g. tool steels or bearing steels); ceramics may be preferable being harder and having lower thermal conductivity; silicon nitride; tungsten carbide; zirconium oxide; boron nitride; diamond. Coated or surface modified materials may also be appropriate, such as nitrided steels, case hardened steels, or ion implanted surfaces. Other surface treatments such as laser glazing for promoting hard and preferably wear resisting surfaces may be used to provide surfaces for use in the present invention.

Another particular feature of the suspension system of such embodiments of the present invention is that it is particularly low profile. As in the embodiment illustrated in FIG. 1, the suspension assembly 20 largely fits into the separation between the first and second articles, requiring only a small protrusion outside of the second article 14. This compares very favourably with known suspension arrangements for retaining a cryogen vessel within an outer vacuum container, using elongate struts or bands, which require significant enlargement of portions of the outer vacuum container in order to accommodate the support members.

The suspension arrangement of the present invention allows a relatively small, adjustable suspension assembly 20 to resist loads in all three xyz axes due to the central spherical element 16 being trapped between the two sets of outer spherical elements 18. This could allow a minimum number of these suspension assemblies 20 to fully constrain a typical cryogenic vessel within an outer vacuum container. A possible system configuration is shown in FIG. 3 using only six suspension assemblies 20 for a horizontal axis, cylindrical vessel set. By using few suspension assemblies 20, the cost would be kept to a minimum, along with the time required to set up preload in each suspension assembly.

The suspension assembly 20 illustrated in FIG. 1 is of course only one exemplary embodiment. Many variations of the suspension assembly may be provided within the scope of the present invention as defined by the appended claims. Some of these alternative embodiments will now be described.

The embodiment of FIG. 1 shows the central spherical element 16 being rather larger than the outer spherical elements 18. This need not be the case. FIGS. 4A and 4B show views analogous to those of FIGS. 1 and 2, respectively, of arrangements wherein the central spherical element 16 is smaller than the outer spherical elements 18. Contact between the various spherical elements will still be at single points, so the thermal conduction of the suspension assembly should not be increased. A limit will be reached, however, in that the central element 16 must be large enough that the outer spherical elements 18 positioned between the central spherical element and the first article do not touch the outer spherical elements 18 positioned between the central spherical element and the second article. Similarly, a minimum relative size of the central spherical element 16 will be required if an intermediate article, such as the thermal shield 30 of FIG. 1, is to be mounted on the central spherical element, for example using a retainer such as shown at 32 in FIG. 1.

FIGS. 5A and 5B show views analogous to those of FIGS. 1 and 2, respectively, of arrangements wherein a set of at least three central spherical elements 52 are provided, braced against a single outer spherical element 54 on each side. Each outer spherical element 54 will be braced against the first article, or the second article, in a manner similar to that illustrated in FIG. 1. If an intermediate article, such as the thermal shield 30 of FIG. 1, is to be mounted between the first and second articles, then a suitable arrangement would need to be provided to mount it onto the set of at least three central spherical elements 52. The central spherical elements must be held together, for example using a retainer such as shown at 32 in FIG. 1.

FIG. 6 shows a view analogous to that of FIGS. 1 and 5A, of arrangements wherein a set of at least three central spherical elements 52 are provided, braced against a single outer spherical element 54 on each side. Contrary to the embodiment illustrated in FIG. 5A, the central spherical elements 52 are smaller than the outer spherical elements 54. The central spherical elements must be held together, for example using a retainer such as shown at 32 in FIG. 1.

FIGS. 7A-7C shows a refinement of the embodiment of FIGS. 5A-5B. Considering the embodiment of FIGS. 5A-5B, for example, it will be apparent that it is not necessary to provide the full spherical surface of the central spherical elements 52. As shown in FIG. 7A, only the relevant part of the spherical surfaces of the central spherical elements 52 need be provided. The resultant part-spheres 56 may be retained within an appropriate retainer such as that shown at 32 in FIG. 1 (not shown in FIG. 7A). FIG. 7B shows a preferred embodiment of such an arrangement, in which part-spheres 56 are retained within an outer ring 58. This outer ring 58 may be a separate article, or the outer ring 58 and part-spheres 56 may be formed together as a single artefact, for example by moulding. Outer spherical element 54 is shown in place, touching the part-spheres 56. FIG. 7C shows a cross-section of the structure of FIG. 7B, along the line VIIC, illustrating outer spherical elements 54 in contact with part-sphere 56, retained by outer ring 58. The separation between outer ring 58 and part sphere 56 is shown dotted, to indicate that the outer ring may, or may not, be part of the same artefact as the part sphere 56.

In addition to these variations on the sizes and placing of the spherical elements, other general variations may be provided within the scope of the present invention. For example, the various spherical elements may be replaced by spheroid elements, or indeed elements of any shape provided that they contact each other at only a single point. Examples may include oblate spheroid, prolate spheroid, cone or truncated cone, pyramid or truncated pyramid, or part surfaces of any of these shapes.

FIGS. 8A-8D show perspective views of cups which may be employed according to a further set of embodiments of the present invention. FIG. 9 shows a cross-section, analogous to that of FIG. 1, of the cups of FIGS. 8A and 8B in use in an embodiment of the present invention.

FIG. 8A shows a cup 80 which has a set of at least three raised convex surfaces 82 on an inner surface of the cup. As illustrated in FIG. 8A, the raised convex surfaces may each be part spherical, or part spheroid, surfaces. In use, as illustrated in the upper portion of FIG. 9, a central element 90, which may be spherical, spheroid or other suitable solid shape, is placed between two confronting cups, such that each raised convex surface 82 of a cup 80 makes a point contact with the central element 90. Adjustment and retaining features, similar to those shown at 22, 24, 26, 32 of FIG. 1, may be provided for the arrangement of FIG. 9. Of course the cup may have more than three raised surfaces which make contact with the central element, although the inventors regard it as preferable to reduce to a minimum the number of contact points in embodiments where low thermal conduction of the suspension assembly is important.

FIG. 8B shows an alternative cup 84 for use in an embodiment of the present invention, as illustrated in the lower portion of FIG. 9. A set of at least three raised surfaces 86 is provided on an inner surface of the cup 84. As illustrated in FIG. 8B, the raised surfaces may, for example, each be convex part cylindrical 86a, or triangular prismatic 86b, surfaces. In use, as illustrated in the upper portion of FIG. 9, a central element 90, which may be spherical, spheroid or other suitable solid shape, is placed between two confronting cups 80, 84, such that each raised surface 86 of each cup makes a point contact with the central element 90. Adjustment and retaining features, similar to those shown at 22, 24, 26, 32 of FIG. 1, may be provided for the arrangement of FIG. 9. Of course the cup may have more than three raised surfaces which make contact with the central element, although the inventors regard it as preferable to reduce to a minimum the number of contact points in embodiments where the thermal conduction of the suspension assembly is important.

FIGS. 8C and 8D show alternative cups 88, 89 for use in embodiments of the present invention, similar to that illustrated in the lower portion of FIG. 9. Cup 88 of FIG. 8C is in the form of a hollow pyramid, or truncated pyramid, having three or more sides. In use, in a manner analogous to that shown in FIG. 9, a central element 90, which may be spherical, spheroid or other suitable solid shape, is placed between two confronting cups, such that each side of each cup makes a point contact with the central element 90. Adjustment and retaining features, similar to those shown at 22, 24, 26, 32 of FIG. 1, may be provided for such an arrangement. FIG. 8D shows a particular embodiment of a cup according to this type of embodiment. Although the cup has six sides and is in the form of a hollow, truncated, hexagonal pyramid, the sides are not of equal length. Long and short sides alternate, such that in use, only the three longer sides make point contact with the central element 90. Of course the cup may have more than three sides which make contact with the central element, although the inventors regard it as preferable to reduce to a minimum the number of contact points in embodiments where the thermal conduction of the suspension assembly is important.

FIGS. 10A-10B illustrate alternative “cup” members, having a substantially planar back plate whereupon a number of features are provided, such features being arranged so as to provide at least three single point contacts with a central element. FIG. 10A shows features 92 in the form of convex hemispheres or part spheroids, while FIG. 10B shows features 94 in the form of convex cones. Other shapes may be employed, provided always that they are arranged so as to provide at least three single point contacts with a central element. The “cup” members of FIGS. 10A and 10B may be employed in a manner analogous to the use of the cups of FIGS. 8A-9.

In all of the embodiments disclosed with reference to FIGS. 8A-10B, it is important that the materials of at least the surfaces of contacting portions of the cup and the central element are hard materials, so that the area of contact does not increase significantly when the suspension assembly is preloaded, or loaded with the weight of the first and second articles. The contacting components must have a compressive strength adequate to support the loads of the system without yielding and therefore increasing the contact area between them.

Suitable hard materials may be: hardened steels (e.g. tool steels or bearing steels); ceramics may be preferable being harder and having lower thermal conductivity; silicon nitride; tungsten carbide; zirconium oxide; boron nitride; diamond. Coated or surface modified materials may also be appropriate, such as nitrided steels, case hardened steels, or ion implanted surfaces. Other surface treatments such as laser glazing for promoting hard and preferably wear resisting surfaces may be used to provide surfaces for use in the present invention.

The above-described embodiments each provide a compression suspension assembly, in that a central member is provided, which is retained in compression by outer members respectively attached to first and second articles. A further set of embodiments of the present invention will now be described. The following embodiments provide tensile suspension assemblies, in that a central member is held in tension between two outer members respectively attached to first and second articles.

FIG. 11 illustrates a suspension assembly 100 according to another embodiment of the present application. In this case, the suspension assembly employs a tensile rod 102 which passes through a hole 101 between at least three rounded surfaces 104 attached to a first article, here the outer vacuum vessel 14. The rounded surfaces 104 may be provided by a cup such as illustrated in FIG. 10A, or a set of spherical elements such as shown at 18 in FIG. 1. A larger element 106 is attached to an end of the tensile rod 102 and bears on the rounded surfaces 104 attached to the first article 14. A similar structure may be provided on a second article, at the other end of the tension rod, in this example the cryogen vessel 12. Tensile preloading may be applied to the tensile rod, for example by operating threaded housing and carrier as illustrated in FIG. 1. The surface of the larger element 106 which bears upon the rounded surfaces 104 is preferably part of a sphere, or a spheroid, but need not be. The essential requirements are that the larger element 106 bears against one or more surfaces 104 mounted on the first article 14 at three or more points; and that the materials of at least the surfaces of contacting portions of the contacting components 106, 104 are hard materials, so that the area of contact does not increase significantly when the suspension assembly is preloaded, or loaded with the weight of the first and second articles. The contacting components 106, 104 must have a compressive strength adequate to support the loads of the system without yielding and therefore increasing the contact area between them. The contact area between the contacting surfaces should be as small as possible, even under load.

Suitable hard materials may be: hardened steels (e.g. tool steels or bearing steels); ceramics may be preferable being harder and having lower thermal conductivity; silicon nitride; tungsten carbide; zirconium oxide; boron nitride; diamond. Coated or surface modified materials may also be appropriate, such as nitrided steels, case hardened steels, or ion implanted surfaces. Other surface treatments such as laser glazing for promoting hard and preferably wear resisting surfaces may be used to provide surfaces for use in the present invention.

In a variation of this embodiment, illustrated in FIG. 12, the larger element 106 may be attached to the first article 14, with bore 108 running therethrough to accommodate the tensile rod 102, with the set of at least three rounded surfaces 104 attached to the end of the tension rod 102, said three rounded surfaces 104 bearing on a surface of the larger element 106. In the embodiment of FIG. 12, the bore 108 is enlarged in conical fashion, to provide increased range of angular movement for tensile rod 102. Adjustable housing 22 and carrier 24 may be provided, to enable preload tension to be applied to the tensile rod 102, or for adjustment of the position of first and second articles.

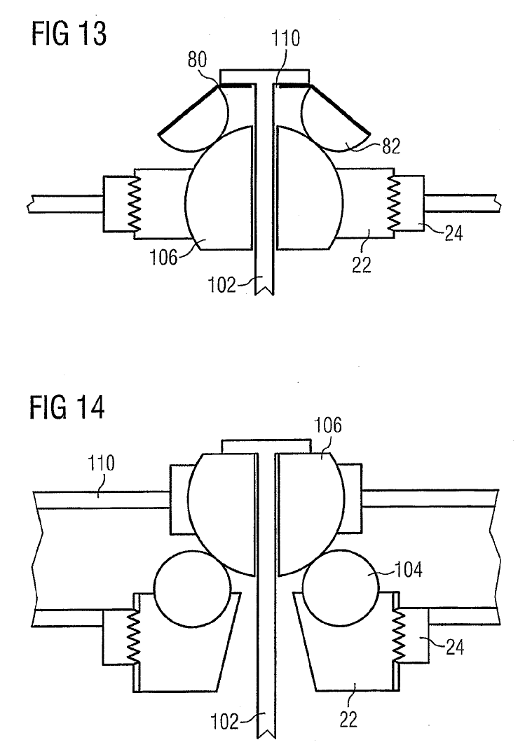

Further variations on the embodiment of FIGS. 11 and 12 may be made, corresponding to the embodiments illustrated in FIGS. 4-10. For example, the relative sizes of the elements 106, 104 may be adjusted. Furthermore cups such as illustrated in FIGS. 8A-10B may be employed to provide the contacting points of the at least one surface 104. Any of the illustrated types of cup, or any of the numerous variants which will be readily apparent to those skilled in the art, may be employed. FIG. 13 illustrates an embodiment of the present invention wherein a cup 80 as illustrated in FIG. 8A is used. Such cup 80 will need to be provided with a through-hole 110 for the passage of the tensile rod 102, or the tensile rod 102 may be mechanically attached to the interior of the cup 80, not passing through a hole in the cup. Cups as discussed may be attached either to the first article 14, in a manner similar to that illustrated in FIG. 11, or to the tensile member 102 in a manner similar to that illustrated in FIG. 13, to provide contact points with a larger element 106 which is placed on the respective other one of the first article 14, or the tensile rod 102.

As already described with reference to certain embodiments, it is preferred that the suspension assembly be provided with a means for applying a preload. In the context of the embodiments of FIGS. 11, 12, this means applying an initial tensile stress to the rod 102. This may be conveniently arranged in a manner similar to that of FIG. 1, wherein the surface 106 or surfaces 104 attached to the first article 14 are mounted on a housing 22 which is provided with a screw thread, and is screwed into a corresponding threaded hole in a carrier 24 mounted on the first article 14. Such arrangements are shown in FIGS. 12, 13.

The second article 102 is preferably also provided with a suspension assembly 100 according to any of the described embodiments, although the invention covers suspension arrangements which employ a suspension assembly 100 at one end only of the tensile rod, with a conventional mounting arrangement at the other end of the tensile rod.

Although many variations on shape are possible, in a preferred embodiment, the surface of the larger element 106 is at least part of a sphere. Such a surface allows the tensile rod 102 to be directed in any direction available, which is constrained at least by the dimensions of the through-hole between the contacting surfaces 104, without difficulty, and without the length of the tensile rod 104 requiring adjustment, which may not be the case with larger elements 106 of other shapes.

In further embodiments, as illustrated by way of example in FIG. 14, which is a development of the embodiment of FIG. 11, further articles 110 may be mounted to the larger element, or the surface(s) 104, in a manner analogous to that illustrated in FIG. 1. However, as will be apparent from a comparison of FIGS. 1 and 14, such further articles will not be positioned between the first and second articles, but will be positioned inside or outside of both the first and second articles.

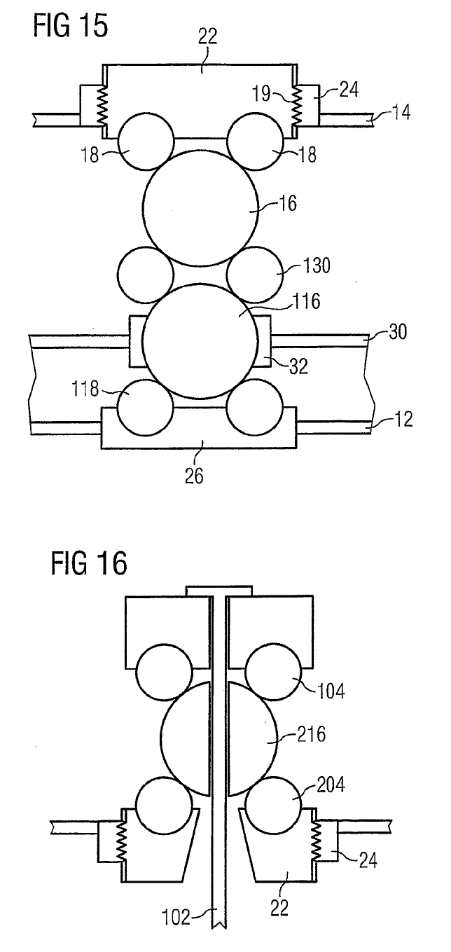

The above described example embodiment each comprise either a single compression suspension assembly, in which a central object is compressed between first and second surfaces, each braced between the central object and a respective one of first and second articles; or a single tensile suspension assembly, in which a tensile rod is linked to a first surface, which bears on a second surface, which is itself mechanically linked to a first article. However, further embodiments of the present invention include further sets of contact points, arranged in series in the thermal path between first and second objects to further increase impedance to thermal conduction through the suspension assembly. For example, FIG. 15 shows an embodiment, based on the embodiment of FIG. 1, wherein a further object 116 is provided, held in compression between second surface 118 and an intermediate surface 130, the original object 16 being held in compression between the first surface 18 and the intermediate surface 130. Similar embodiments may readily be envisaged, based on the embodiments of FIGS. 4A-10B. Furthermore, FIG. 16 shows an embodiment, based on a combination of the embodiments of FIGS. 12 and 14, wherein an intermediate object 216 is provided, held in compression between first surface 104 and second surface 204. Similar embodiments may readily be envisaged, based on the embodiments of FIGS. 11-14.

While the present invention has been described with reference to a limited number of particular embodiments, one skilled in the art will understand that numerous variations may be made within the scope of the claimed invention.

1. A suspension assembly for mechanically retaining a first article by bracing it against a second article, comprising:
an object located between first and second articles;
at least one first surface mechanically braced between the object and the first article, said surface presenting at least three separate points of contact with the object; and
at least one second surface mechanically braced between the object and the second article, said surface presenting at least three separate points of contact with the object.

2. The suspension assembly according to claim 1 wherein the object has a convex surface.

3. The suspension assembly according to claim 1, wherein the first surface is convex, at least at one of the separate points of contact with the object.

4. The suspension assembly according to claim 1, wherein the second surface is convex, at least at one of the separate points of contact with the object.

5. The suspension assembly according to claim 1, wherein:
at least one of the points of contact is presented by a part of one of the respective first and second surfaces; and
said part of one of the respective first and second surfaces is at least a partial sphere or a spheroid.

6. The suspension assembly according to claim 1, wherein at least one of the points of contact contacts the object at a portion of its surface which is a part of a sphere or a spheroid.

7. The suspension assembly according to claim 1, wherein the object is one of spheroidal and spherical.

8. The suspension assembly according to claim 1, wherein one of the first surface and the second surface comprises a set of at least three objects retained together in fixed relative positions, said objects being one of spheroidal and spherical.

9. The suspension assembly according to claim 1, wherein one of the first surface and the second surface comprises an article having at least three part spherical or part spheroidal surfaces retained together in fixed relative positions.

10. The suspension assembly according to claim 1, wherein one of the first surface and the second surface comprises an interior surface of a cup having a corresponding at least three protrusions on said interior surface.

11. The suspension assembly according to claim 1, wherein:
one of the first surface and the second surface comprises an interior surface of a cup; and
said interior surface comprises one of a hollow pyramid and a hollow truncated pyramid.

12. The suspension assembly according to claim 11, wherein:
the interior surface of the cup comprises one of a hollow hexagonal pyramid and a hollow hexagonal truncated pyramid; and
alternate sides of the hexagonal pyramid are larger than intervening sides.

13. The suspension assembly according to claim 1, wherein one of the first surface and the second surface comprises a substantially planar backplate having a number of protrusions thereon.

14. The suspension assembly according to claim 7, wherein a radius of the spherical or spheroidal object is greater than a radius of each of the set of at least three spherical or spheroid objects.

15. The suspension assembly according to claim 1, wherein at least one of the first and the second surfaces is one of spheroidal or spherical.

16. The suspension assembly according to claim 1, wherein the object comprises a set of at least three objects retained together in fixed relative positions, which objects are one of spheroidal and spherical.

17. The suspension assembly according to claim 1, wherein the object comprises at least three surfaces retained together in fixed relative positions, which surfaces are one of part spherical and part spheroidal.

18. The suspension assembly according to claim 1, wherein at least one of the first and second surfaces is braced against the corresponding first or second article through an adjustment device which may be adjusted to apply a mechanical compressive preload to the object.

19. The suspension assembly according to claim 1, further comprising:
an additional object that is held in compression between second surface and an intermediate surface;
wherein the additional object is held in compression between the first surface and the intermediate surface.

20. A cryostat comprising:
a cryogen vessel;
an outer vacuum vessel;
wherein the cryogen vessel is restrained and supported within the outer vacuum vessel by a suspension system comprising at least one suspension assembly according to claim 1.

21. A suspension assembly for mechanically retaining a first article by bracing it against a second article, comprising:
an object located between first and second articles, which object is one of spherical and spheroidal;
a first set of at least three rounded surfaces mechanically braced between the spherical or spheroid object and the first article, each of said surfaces being in contact with the spheroid object at a single point; and
a second set of at least three rounded surfaces mechanically braced between the spherical or spheroid object and the first article, each of said surfaces being in contact with the spherical or spheroid object at a single point.

22. The suspension assembly according to claim 21, wherein the rounded surfaces each comprise at least a part of a sphere.

23. The suspension assembly according to claim 21, wherein the object is spherical.

24. The suspension assembly according to claim 21, wherein a radius of the object is greater than a radius of each of the rounded surfaces.

25. The suspension assembly according to claim 21, wherein at least one of the first and second sets of rounded surfaces is braced against the corresponding first or second article through an adjustment device which may be adjusted to apply a mechanical compressive preload to the suspension assembly.

26. A cryostat comprising a cryogen vessel retained within an outer vacuum vessel by a suspension system comprising at least one suspension assembly according to claim 1, wherein the first article is a cryogen vessel and the second article is an outer vacuum vessel.

27. The cryostat according to claim 26, further comprising a radiation shield interposed between the cryogen vessel and the outer vacuum vessel, said radiation shield being mechanically supported in position by a supporting structure mounted to the spherical or spheroidal object.
